(19) United States
(12) Patent Application Publication
(10) Pub. No.: US 2021/0012594 A1
(43) Pub. Date: Jan. 14, 2021

(54) Method For Providing Damage Information On A Motor Vehicle To An External Information Center, As Well As Motor Vehicle And Vehicle Breakdown Emergency Call System

(71) Applicant: Volkswagen Aktiengesellschaft, Wolfsburg (DE)

(72) Inventors: Yigiterkut Canpolat, Witten (DE); Thorsten Ströher, Bischhoffen (DE)

(73) Assignee: Volkswagen Aktiengesellschaft, Wolfsburg (DE)

(21) Appl. No.: 16/923,300

(22) Filed: Jul. 8, 2020

(30) Foreign Application Priority Data
Jul. 8, 2019 (DE) 10 2019 210 014.7

(51) Int. Cl. G07C 5/08; G07C 5/00; H04W 76/50

(52) U.S. Cl. CPC G07C 5/0833; G07C 5/0808; H04W 76/50; G07C 5/0825; G07C 5/008

(57) ABSTRACT

The invention relates to a method for providing damage information on a motor vehicle to an external information center, wherein a breakdown emergency call by the motor vehicle is activated in a case of damage to the motor vehicle, and a communication link to the external information center is established, a communication link is established between a portable communication terminal of a user of the motor vehicle and a communication module of the motor vehicle and/or directly with the information center, with the portable communication terminal, first an image and/or at least one audio sequence is generated that contains damage information on the motor vehicle, and the at least one image and/or audio sequence is transmitted at least to the external information center.

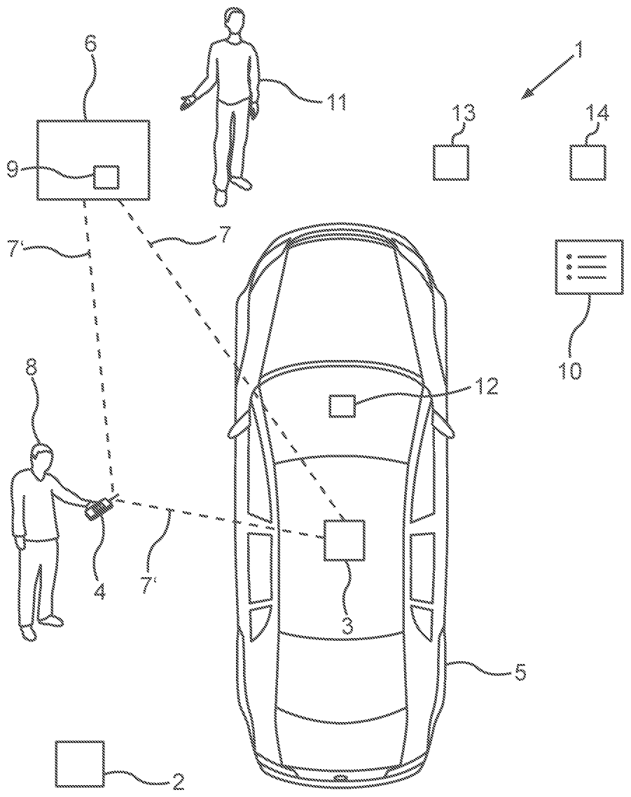

### CROSS-REFERENCE TO RELATED APPLICATIONS

This application claims priority to German Patent Application No. DE 10 2019 210 014.7, filed on Jul. 8, 2019 with the German Patent and Trademark Office. The contents of the aforesaid patent application are incorporated herein for all purposes.

### TECHNICAL FIELD

The invention relates to a method for providing damage information on a motor vehicle to an external information center, wherein a breakdown emergency call by the motor vehicle is activated in a case of damage to the motor vehicle, and a communication link is established with the external information center. The invention also relates to a vehicle breakdown emergency call system with an evaluating unit. Likewise, the invention relates to a motor vehicle.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

DE 10 2014 221 607 A1 discloses a method for diagnosing disturbing noises in a motor vehicle, wherein the vehicle has at least one microphone signal processing system that can be configured to work with two different audio signals. A first audio signal filter for transmitting human speech is adapted, and a second audio signal filter is for recognizing disturbing noises in a vehicle. In a first mode, the at least one microphone and the signal processing system are operated using the first audio signal filter. With the assistance of the microphone and the signal processing system, the recordings obtained in the first mode are recorded and/or transmitted. In a second mode, a request is received, wherein the request has input from a passenger of the vehicle, or is received from a remote site, in particular a server. In a second mode, the at least one microphone and the signal processing system are processed using the second audio signal.

EP 0 982 697 B1 discloses a method for processing a breakdown emergency call sent by a vehicle to a breakdown emergency call service center or service center, wherein the breakdown emergency call service center requests from the vehicle, by means of a request message, vehicle status data relevant to the type of breakdown after receiving the emergency call, and the vehicle status data are transmitted back by a terminal in the vehicle.

DE 20 2015 006 555 U1 discloses a system for handling an emergency call. Emergency calls are conventionally not received by telephone or telefax, but rather by SMS and/or by Internet-based short message services such as WhatsApp and other services, with the option for transmission to receive and send text data, standard data, image data, video data and voice data.

CN 10 130 37 61 relates to a method for using a cell phone to record images or videos in real time while simultaneously embedding the recorded forensic information in images or videos, and for uploading images and videos with recorded forensic information to a server image database in real time to settle motor vehicle insurance claims.

This results in a disadvantage that only vehicle data are transmitted as electrical signals by control devices to a workshop or to a call center agent in the event of a breakdown emergency call, and perhaps only an audio conversation is initiated with this agent.

### SUMMARY

An object is to provide a method, a vehicle breakdown emergency call system and a motor vehicle with which a case of breakdown and/or repair of a motor vehicle can be quickly evaluated more efficiently.

This object is solved by a method, a vehicle breakdown emergency call system and a motor vehicle according to the independent claims. Embodiments of the invention are discussed in the dependent claims and the following description.
In one exemplary aspect, a method for providing damage information of a motor vehicle to an external information center is provided. The method comprises:
activating a breakdown emergency call by the motor vehicle in a case of damage to the motor vehicle, and establishing a communication link to the external information center;
establishing another communication link between a portable communication terminal of a user of the motor vehicle and one or more of a communication module of the motor vehicle and the information center;
with the portable communication terminal, generating at least one image and/or at least one audio sequence that contains damage information of the motor vehicle; and
transmitting the at least one image and/or the at least one audio sequence at least to the external information center.

The details of one or more embodiments are set forth in the accompanying drawings and the description below. Other features will be apparent from the description, drawings, and from the claims.

### BRIEF DESCRIPTION OF THE DRAWING

The single FIG. shows an embodiment of a vehicle breakdown emergency call system for providing damage information on a motor vehicle to an external information center.

### DESCRIPTION

Specific embodiments of the invention are described in detail, below. In the following description of embodiments of the invention, the specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

A first exemplary aspect relates to a method for providing damage information on a motor vehicle to an external information center, wherein a breakdown emergency call by the motor vehicle is activated in a case of damage to the motor vehicle. A communication link is established by the motor vehicle with the external information center. A communication link is established between a portable communication terminal of a user of the motor vehicle and a communication module of the motor vehicle, and/or directly with the information center. For example, this may be done automatically when a communication link is established between the motor vehicle and the external information center. Automatic establishment may for example occur simultaneous to or at a delay from the establishment of the communication link between the motor vehicle and the external information source. With the portable communication terminal, at least an image and/or at least one audio sequence is generated that contains damage information on the motor vehicle. The at least one image and/or the audio sequence is transmitted at least to the external information site, for example via the established communication link between the communication terminal and the external information center or the communication module. By generating the at least one image and/or the at least one audio sequence, damage to the motor vehicle may for example be immediately recorded and displayed visually and/or acoustically. A plurality of individual images or a video may, e.g., be recorded. For example, a live video stream with the information center may, e.g., be immediately effectuated by the portable communication terminal so that in the event of a case of damage to the motor vehicle, the occurring damage to the motor vehicle may, e.g., be provided to the at least one external information center and beneficially displayed. Consequently, for example when a breakdown emergency call by the motor vehicle is activated, immediate assistance and/or supportive measures may be provided to the user employing the transmitted images and audio sequences. In some embodiments, a repair service, breakdown service and/or accident service can be revalued via the present aspect and displayed and offered in greater detail to a user of the motor vehicle.

A breakdown emergency call may for example be a placed emergency call for a vehicle breakdown and/or for vehicle damage. The breakdown emergency call may be activated by a breakdown emergency call actuation element being actuated by a user of the motor vehicle, or may be automatically activated by a system of the motor vehicle for an occurred event of damage to the motor vehicle.

The communication link with the external information center may be established for example by wireless communication via for example Bluetooth, WLAN, 4G, LTE or UMTS. In some embodiments, the communication link is established by automatically activating the breakdown emergency call with the external information center. It would also be conceivable in corresponding embodiments for a plurality of communication links with different external information centers to be established simultaneously. In the event of a successful establishment of the communication link, e.g., a communication link by a portable communication terminal of the user of the motor vehicle is automatically established with the communication module of the motor vehicle and/or directly with the information center.

The portable communication terminal of the user may for example be a smart phone or a tablet. The communication module may for example either be a separate communication unit in the vehicle, or part of the infotainment system of a motor vehicle.

In some embodiments, the user can record and generate the image and/or the at least one audio sequence with the assistance of the camera and the speaker of the portable communication terminal. With the assistance of the portable communication terminal, for example body damage to the motor vehicle, and visual damage to the interior and/or exterior of the motor vehicle may be recorded. With the audio sequence, for example disturbing noises by the V-belt and/or transmission of the motor vehicle may be recorded and transmitted to the external information center. By means of the generated images and/or audio sequences, damage can be better described and documented especially in the case of damage to the motor vehicle. Consequently, the at least one external information center is able to better analyze the damage to the motor vehicle.

The motor vehicle may in some embodiments be an electrically operable vehicle, or a hybrid vehicle, or a motor vehicle with only an internal combustion engine. It is also conceivable for the motor vehicle to be a vehicle that can be operated partially autonomously or fully autonomously.

In some embodiments, it is provided that at least one image and/or audio sequence is transmitted manually by the user and/or automatically, depending on a decision criterion, to the external information center. Consequently, the generated image and audio sequences may also be transmitted continuously to the information center. For example, immediate automatic transmission of the information may be carried out in case of damage with a higher priority so that very rapid support, or respectively assistance may be provided to the user in case of damage to the motor vehicle. “Automatic transmission” means that the user does not have to release the transmission by an additional activation process. Once the communication link has been established and at least one image has been recorded, the at least one image may be automatically transmitted. For example in the case of damage with a low priority, the user may manually decide if or when to transmit the images and/or the audio sequences to the external information center. In some embodiments, a vehicle-system-dependent decision criterion may automatically transmit the image and audio sequences to the external information center. The decision criteria may in some embodiments be predefined, or respectively predetermined, wherein the possible cases of damage are categorized beforehand in a priority list. Depending on the type of case of damage, the system may, with the assistance of the decision criteria, decide the priority at which an immediate and automatic transmission of the image and/or audio sequences to the external information center is necessary.

In some embodiments it is provided that the at least one transmitted image or the audio sequence is analyzed and prepared by the external information center, and a damage diagnosis is carried out by the external information center depending on the analyzed and prepared image and/or the audio sequence. With the assistance of the communication link, the images and/or the audio sequences are transmitted manually and/or automatically to the external information center. After receipt of the image and/or audio sequences at a receiving unit of the external information center, the image and/or audio sequences are analyzed and correspondingly prepared with the assistance of a processing unit. In some embodiments, the corresponding damage diagnosis of the current case of damage to the motor vehicle may be performed, or respectively produced and/or generated by the processing unit of the external information center depending on the transmitted, analyzed and/or prepared image and/or audio sequences. The damage diagnosis may in some embodiments be a repair diagnosis process and/or an accident management process. For example, repairs and/or support for the occurring case of damage to the motor vehicle may be provided to the user by the damage diagnosis. For example, a preliminary diagnosis may be carried out with the damage diagnosis. Accordingly, the potential expenditure of time and money for rectifying the case of damage to the motor vehicle may be estimated and displayed to the user. With the assistance of the damage diagnosis, it is possible to accelerate and improve a potential repair process to the motor vehicle.

In some embodiments, depending on the performed damage diagnosis, a repair measure and/or a procedure is provided, and the provided repair measure and/or procedure is transmitted to the communication module of the motor vehicle, and/or to the portable communication terminal of the user. By transmitting the repair measures and/or the procedure, immediate assistance and/or support in case of damage to the motor vehicle can be offered, e.g., to the user of the motor vehicle. For example, the user of the motor vehicle may accordingly initiate an immediate measure to counteract the damage to the motor vehicle. Likewise, certain repairs may accordingly be performed by the user in the case of damage. For example, the corresponding repair measure and/or procedure may be transmitted directly to the portable communication terminal of the user or to the communication module of the motor vehicle through the communication link. For example, the repair measures and/or the procedures may be displayed and output on the infotainment system of the motor vehicle. For example, the repair measures and/or procedures may be transmitted as a video file, or audio file, or image file to the communication module or to the portable communication terminal.

In some embodiments, it is provided that the at least one image, and/or the audio sequence, and/or the damage diagnosis, and/or the repair measures, and/or procedures may be saved in an external database and retrieved by the information center and/or the user in the event of a future case of damage to the motor vehicle. By saving the images, and/or the audio sequence, and/or the damage diagnosis, and/or the repair measures, and/or the procedures in the external database, better and faster measures can be pursued in the event of future occurring cases of damage to the motor vehicle, and, e.g., faster assistance can be offered to the user. For example, all of these data can be taken into account when preparing reports and/or histories so that special histories may be produced depending on the cases of damage and/or the motor vehicle. These may for example be taken into account and used by the external information center when producing damage diagnoses and repair measures and procedures. Consequently, more comprehensive and improved support and/or assistance for a user can be provided in the event of a case of damage to the motor vehicle.

In some embodiments, it is provided that transmitting the at least one image and/or audio sequence to the external information center is performed in real time. Consequently, current damage information on the currently occurred case of damage to the motor vehicle can be provided in particular to the external information center. In some embodiments with the assistance of the portable communication terminal, a real-time-capable live video transmission to the external information center of the current case of damage to the motor vehicle can be carried out. In some embodiments with the assistance of the communication link, a real-time-capable image file, and/or video file, and/or audio file can be transmitted to the at least one external information center. Consequently, the external information center may, e.g., perform an improved analysis and preparation of the transmitted image and/or audio sequences, and may for example provide an improved damage diagnosis to the motor vehicle, and/or the user of the motor vehicle, and/or the external information center. For example, the images and/or audio signals may be transmitted with the assistance of real-time-capable applications of the portable communication terminal. For example, the damage information may be transmitted and provided to the external information center in real time with smart phone applications such as for example Skype, or WhatsApp, or another video communication channel.

In some embodiments, it is moreover provided that a bidirectional interaction, such as a video call, is carried out between the user of the motor vehicle and an employee of the external information center by the portable communication terminal of the user so that additional information may be provided to the employee of the external information center in addition to the at least one image and/or audio sequence. Through the provided interaction between the user and the employee of the information center, current damage information in case of damage to the motor vehicle may be displayed to the user. Accordingly, the employee of the information center may be able to better analyze and assess the case of damage to the motor vehicle. In some embodiments, an improved damage diagnosis of the case of damage to the motor vehicle may accordingly be performed, so that improved and more efficient repair measures and/or procedures may be provided to the user of the motor vehicle. In some embodiments, the interaction occurs through a video call and/or audio call between the user and the employee of the external information center. For example with the assistance of the portable communication terminal of the user, a live transmission with the employee can be carried out so that the employee can be immediately shown damage to the motor vehicle.

It is for example possible that the at least one produced image and/or the audio sequence is transmitted by the communication module of the motor vehicle and/or by the portable communication terminal to a service workshop, and/or to an insurance company, and/or to a breakdown service as the external information center. Therefore, in case of damage to the motor vehicle, the damage information may be used more comprehensively in that different external information centers are supplied with the image and/or the audio sequences. Thus, a greater variety of assistance and/or support measures may be provided to the user in the case of damage. Consequently for example preliminary diagnoses may be produced, or possible repair processes may be simplified and accelerated after the case of damage. With the insurance company, damage analyses may be performed using the image and/or audio sequences so that a potential insured event and/or case of repair can be processed as quickly as possible.

In some embodiments, it is provided that the breakdown emergency call normally leads to a link with an emergency center of the vehicle manufacturer. This emergency call center may be an authorized workshop, for example one of the vehicle manufacturer, or an emergency call agent of the vehicle manufacturer. In addition to this standard link, it may be provided that an additional communication link with another external information center may be established. This may be done by the user himself. In this case as well however, an automatic link may be established. For example, this may be done depending on a user-individual pre-configuration, for example of the communication terminal, and/or depending on the image information of the recorded image, and/or the audio sequence, and/or by the emergency call center. The additional external information center may be an insurance service provider, for example the one with which the motor vehicle is insured, and/or a service workshop independent from the vehicle manufacturer.

With a workshop as the external information center, the required measures for the pending repair of the damage to the motor vehicle may be analyzed in advance using the transmitted image and/or audio sequences. This may reduce unnecessary wait times for potential replacement part orders, and, e.g., a repair date may be proposed and offered to the user very quickly. In some embodiments, potential replacement parts may be procured immediately.

Another exemplary aspect of the present disclosure relates to a vehicle breakdown emergency call system with an evaluation unit, a communication module and a portable communication terminal, wherein the vehicle breakdown emergency call system is designed to execute the method according to the first exemplary aspect and/or one of the above-described embodiments of the method. In some embodiments, the method is executed with the vehicle breakdown emergency call system.

Another exemplary aspect of the present disclosure relates to a motor vehicle with a vehicle breakdown emergency call system according to the preceding aspect and/or on one of the above-described embodiments.

Also belonging to the present disclosure are embodiments of the motor vehicle and of the vehicle breakdown emergency call system that have features/limitations which are described in the preceding in conjunction with the embodiments of the method according to the first aspect. For this reason, the corresponding embodiments of the motor vehicle and of the vehicle breakdown emergency call system are not described here again.

The present disclosure also includes combinations of the features of the described embodiments.

In the following, further exemplary embodiments are described. In this regard, the single FIG. shows an illustrative embodiment of a vehicle breakdown emergency call system for providing damage information on a motor vehicle to an external information center.

Reference will now be made to the drawings in which the various elements of embodiments will be given numerical designations and in which further embodiments will be discussed.

Specific references to components, process steps, and other elements are not intended to be limiting. It is further noted that the single FIG. is schematic and provided for guidance to the skilled reader and is not necessarily drawn to scale. Rather, the various drawing scales, aspect ratios, and numbers of components shown in the single FIG. may be purposely distorted to make certain features or relationships easier to understand.

In the following exemplary embodiments, the described components of the embodiments each represent individual features that should be considered independent of each other, and each also develop the embodiments independently from each other and should therefore be considered as a part of the embodiments both individually or in a combination other than that shown. In addition, the described embodiments can also be supplemented by other features than those already described.

The single FIG. shows a vehicle breakdown emergency call system 1 with an evaluation unit 2, a communication module 3 and a portable communication terminal 4. With the vehicle breakdown emergency call system 1, in particular damage information on a motor vehicle 5 can be provided to an external information center 6. The damage information is in particular provided to the external information center 6 in a case of damage to the motor vehicle 5. In the case of damage to the motor vehicle 5, in particular a breakdown emergency call by the motor vehicle 5 is activated by the user or automatically, and then a communication link 7 is automatically established as a predetermined, or respectively pre-set standards link to the external information center 6. Given a successfully established communication link 7, the damage information is for example automatically transmitted to the external information center 6. In particular simultaneous to or at a delay from the establishment of the communication link 7, a communication link 7′ is established directly between the communication terminal 4 of a user 8 of the motor vehicle 5 and the external information center, or such a communication link 7′ is established with the communication module 3.

A communication link 7, 7′ is in particular a wireless link such as for example a WLAN, Bluetooth, 3G, or 4G link.

The portable communication terminal 4, generates at least one image and/or at least one audio sequence which contains damage information on the motor vehicle 5. This is recorded by the user 8 using the communication terminal 8. The portable communication terminal 4 is for example a smart phone or a tablet of the user 8.

The images and/or the audio sequences are recorded and produced by means of a camera and/or a speaker of the portable communication terminal 4. The produced images and/or audio sequences may for example be transmitted by the portable communication terminal 4 or by the communication module 3 to the at least one external information center 6. In particular, this is done automatically, in particular in real time.

The communication module 3 may for example be installed as an external unit in the motor vehicle 5, or a vehicle system may be used as the communication module 3 such as for example an infotainment system of the motor vehicle 5.

The external information center 6 is for example a service workshop, and/or an insurance company, and/or a breakdown service. In particular, a corresponding external information center is automatically informed in a breakdown emergency call via the communication link 7 about the occurring case of damage to the motor vehicle 5.

For example, images, audio sequences, videos, sounds, image sequences or live transmissions can be produced by the portable communication terminal 4 and transmitted through the communication module 3 to the external information center 6 through the communication link 7′, or through the communication links 7 and 7′.

For example, the images and/or at least one audio sequence can be produced and prepared by the evaluation unit 2 of the vehicle breakdown emergency call system 1. The evaluation unit 2 can in particular be part of the external information center 6, or function as an external unit.

The produced images and/or audio sequences with the assistance of the portable communication terminal 4 can be transmitted to the external information center 6 manually by the user 8 and/or automatically depending on a decision criterion. The transmitted image and/or audio sequences can be analyzed and prepared by the external information center 6. In particular, a processing unit 9 of the external information center 6 analyzes and prepares the transmitted image and/or audio sequences. The processing unit 9 and/or the information center 6 can produce and provide a damage diagnosis depending on the analyzed and prepared image and/or audio sequences. Depending on the produced damage diagnosis, repair measures and/or procedures can be provided, wherein the provided repair measures and/or procedures are transmitted via the communication link 7 to the communication module 3 of the motor vehicle 5, and/or to the portable communication terminal of the user 8. Because of that supportive measures and/or assistive measures can be provided to the user 8 in the event of the case of damage to the motor vehicle 5. For example, these repair measures and/or procedures can also be provided to external workshops or repair services. Potential repairs to the damage to the motor vehicle 5 can therefore be prepared in advance, and corresponding replacement parts and capacities can be provided.

In particular, the produced images, and/or the audio sequences, and/or the damage diagnosis, and/or the repair measure, and or procedures can be saved in an external database 10 and retrieved by the external information center 6 and/or the user 8 in the event of a future case of damage to the motor vehicle 5. The cases of damage to the motor vehicle 5 occurring in the future can accordingly be analyzed and prepared in greater detail and more comprehensively by taking into account the past cases of damage, or respectively past damage information on the motor vehicle 5.

With the assistance of the portable communication terminal 4 of the user 8 and the communication link 7, the produced images and/or audio sequences can be transmitted to the external information center 6 in real time. Thus, the current damage information of the currently occurred case of damage to the motor vehicle 5 can be immediately provided to the external information center 6. For example, the damage to the motor vehicle 5 can be displayed live and transmitted to the external information center 6 by a real-time-capable live transmission with the assistance of the camera of the portable communication terminal 4. As a result, auxiliary measures can be provided to the user 8 as quickly as possible in the case of damage. In particular a bidirectional interaction between the user 8 of the motor vehicle 5 and an employee 11 of the external information center 6 can be carried out with the portable communication terminal 4 of the user 8. Thus, the information center 6, or respectively the employee 11 of the external information center 6, can be provided with additional information about the interactions carried out between the user 8 and the employee 11 by the transmitted image and/or audio sequences. Because of that, improved immediate measures, and/or repair measures, and/or damage diagnoses of the current case of damage to the motor vehicle 5 can be carried out.

For example, the performed interactions between the user 8 and the employee 11 can also be saved in the external database 10 and used for later reports or histories. The external database 10 is in particular an external server or a cloud.

In particular, the user 8 can activate the breakdown call of the motor vehicle 5 in the case of damage to the motor vehicle 5 by an emergency call breakdown button 12. It is likewise conceivable for a breakdown emergency call to be activated by the user 8 through an application of the portable communication terminal 4. When the breakdown emergency call is automatically activated, the breakdown emergency call is activated by a vehicle guidance system, or by a system of the motor vehicle 5.

For example, the case of damage to the motor vehicle 5 can be a breakdown situation during a driving mode of the motor vehicle 5 in an example of use of the proposed system and method. When the breakdown situation of the motor vehicle 5 is ascertained by the user 8 or by a vehicle guidance system of the motor vehicle 5, either the user 8 can activate the breakdown emergency call using the emergency call breakdown button 12, or the vehicle 5 automatically activates it. After the breakdown emergency call is activated, the communication link 7 is established with the breakdown service as the external information center 6. In particular, the employee 11 of the breakdown service receives the breakdown emergency call. For example, the user 8 can show the employee 11 images and/or audio sequences of the current breakdown situation of the motor vehicle 5 using the portable communication terminal 4. For example, the data can be transmitted to the breakdown service with the assistance of a Car-Net app.

For example, the employee 11 can have the current cause of the breakdown of the motor vehicle 5 displayed with the assistance of a real-time-capable live transmission of the current breakdown situation. Thus, for example the reasons for the breakdown can be better assessed, and corresponding repair measures and/or procedures can be prepared, or respectively provided. Likewise, the employee 11 of the external information center 6 can present corresponding instructions to the user 8 with the assistance of the live-transmitted breakdown situation and possibly be able to eliminate the causes of the breakdown directly on site. Otherwise, the employee 11 can forward this information to a workshop, or respectively an authorized workshop with the assistance of the performed damage diagnosis so that a repair and/or assistance for the user 8 of the motor vehicle 5 can be provided as quickly as possible.

In particular, vehicle data and vehicle-specific information can be sent to the external information center 6 through the communication module 3 in addition to the produced image and/or audio sequences. These can be used in addition to creating the damage diagnosis. Therefore, the vehicle data do not have to first be read out during a repair, but are instead already available in advance to the information center 6. Consequently, a repair of the motor vehicle 5 can be performed faster and more efficiently.

In another possible example of use, occurred damage, in particular property damage, to the motor vehicle 5 can be provided to the external information center as the damage information to the external information center 6. After the breakdown emergency call of the motor vehicle 5 is actuated with the assistance of the emergency call breakdown button 12, the communication link 7, 7′ can be established with a service workshop as the external information center 6 so that an employee 11 of the service workshop can receive the emergency call and have an overview displayed of the occurred property damage to the motor vehicle 5. The property damage can in particular be body damage, visual damage in the interior and/or exterior region of the motor vehicle 5, or disturbing noises in the V-belt or transmission. The employee 11 can very precisely analyze the current property damage with the assistance of the transmitted image and/or audio sequences and can provide corresponding preparations and/or countermeasures. In particular, repair dates can accordingly be established in advance, and in particular required replacement parts can be provided. For example, the employee 11 of the service workshop can make a preliminary diagnosis in order to estimate the potential time expenditure and/or financial expense. Consequently, a repair process can be carried out more rapidly. In particular, help can consequently be provided to the user 8 of the motor vehicle 5 as quickly as possible.

For example, the proposed system can also be used as an accident damage management system. For example after an accident to the motor vehicle 5, the communication link 7′ can also be established with the assistance of the emergency call breakdown button 12 with an insurance company 13 as an additional external information center 6, and/or a workshop 14 that is in particular independent from the vehicle manufacturer as an external information center 6. The workshop can also be a breakdown service such as for example a towing service. The employee 11 of the insurance company can accept the incoming call and have a first overview shown to him with the assistance of the transmitted image and/or audio sequences. The transmitted image and/or audio sequences and/or vehicle-specific information are digitized and documented and then cached for example in the external database 10. Therefore, the damage can be better analyzed, and a subsequent report, or respectively accident report, can be prepared. More comprehensive documentation and reports on arisen damage, in particular property damage, to the motor vehicle 5 can therefore be better estimated, evaluated and documented. The ongoing processes after an accident can consequently be simplified and accelerated.

### LIST OF REFERENCE NUMERALS

1 Vehicle breakdown emergency call system
2 Evaluation unit
3 Communication module
4 Portable communication terminal
5 Motor vehicle
6 Information center
7 Communication link
8 User
9 Processing unit
10 Database
11 Employee
12 Emergency call breakdown button
13 Insurance service provider
14 Workshop

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for providing damage information of a motor vehicle to an external information center, comprising:
activating a breakdown emergency call by the motor vehicle in a case of damage to the motor vehicle, and establishing a communication link to the external information center;
establishing another communication link between a portable communication terminal of a user of the motor vehicle and one or more of a communication module of the motor vehicle and the information center;
with the portable communication terminal, generating at least one image and/or at least one audio sequence that contains damage information of the motor vehicle; and
transmitting the at least one image and/or the at least one audio sequence at least to the external information center.

2. The method of claim 1, wherein the at least one image and/or the at least one audio sequence is transmitted, depending on a decision criterion, to the external information center.

3. The method of claim 1, wherein the at least one transmitted image and/or the at least one transmitted audio sequence is analyzed and prepared by the external information center, and a damage diagnosis is carried out by the external information center depending on the analyzed and prepared at least one image and/or the at least one audio sequence.

4. The method of claim 3, wherein depending on the performed damage diagnosis, one or more of a repair measure and a procedure is provided, and the provided one or more repair measure and procedure is transmitted to one or more of the communication module of the motor vehicle, and to the portable communication terminal of the user.

5. The method of claim 3, wherein one or more of the at least one image, the at least one audio sequence, the damage diagnosis, the repair measures, and the procedures are saved in an external database and retrieved by the external information center and/or the user in the event of a future case of damage to the motor vehicle.

6. The method of claim 1, wherein the transmission of the at least one image and/or the at least one audio sequence to the external information center is performed in real time.

7. The method of claim 1, wherein a bidirectional interaction is carried out between the portable communication terminal and the external information center, so that additional information are provided to the external information center in addition to the at least one transmitted image and/or audio sequence.

8. The method of claim 1, wherein the at least one image and/or the at least one audio sequence is transmitted by the communication module of the motor vehicle and/or by the portable communication terminal to one or more of a service workshop, an insurance company, and a breakdown service as the external information center.

9. A vehicle breakdown emergency call system with an evaluation unit, a communication module and a portable communication terminal, wherein the vehicle breakdown emergency call system is designed to execute the method according to claim 1.

10. A motor vehicle having a vehicle breakdown emergency call system according to claim 9.

11. The method of claim 2, wherein the at least one transmitted image and/or the at least one audio sequence is analyzed and prepared by the external information center, and a damage diagnosis is carried out by the external information center depending on the analyzed and prepared at least one image and/or the at least one audio sequence.

12. The method of claim 4, wherein one or more of the at least one image, the at least one audio sequence, the damage diagnosis, the repair measures, and the procedures are saved in an external database and retrieved by the external information center and/or the user in the event of a future case of damage to the motor vehicle.

13. The method of claim 2, wherein the transmission of the at least one image and/or the at least one audio sequence to the external information center is performed in real time.

14. The method of claim 3, wherein the transmission of the at least one image and/or the at least one audio sequence to the external information center is performed in real time.

15. The method of claim 4, wherein the transmission of the at least one image and/or the at least one audio sequence to the external information center is performed in real time.

16. The method of claim 5, wherein the transmission of the at least one image and/or the at least one audio sequence to the external information center is performed in real time.

17. The method of claim 2, wherein the at least one image and/or the at least one audio sequence is transmitted by the communication module of the motor vehicle and/or by the portable communication terminal to one or more of a service workshop, an insurance company, and a breakdown service as the external information center.

18. The method of claim 3, wherein the at least one image and/or the at least one audio sequence is transmitted by the communication module of the motor vehicle and/or by the portable communication terminal to one or more of a service workshop, an insurance company, and a breakdown service as the external information center.

19. The method of claim 4, wherein the at least one image and/or the at least one audio sequence is transmitted by the communication module of the motor vehicle and/or by the portable communication terminal to one or more of a service workshop, an insurance company, and a breakdown service as the external information center.

20. The method of claim 5, wherein the at least one image and/or the at least one audio sequence is transmitted by the communication module of the motor vehicle and/or by the portable communication terminal to one or more of a service workshop, an insurance company, and a breakdown service as the external information center.
